(19) United States
(12) Patent Application Publication
(10) Pub. No.: US 2005/0029463 A1
(43) Pub. Date: Feb. 10, 2005

(54) Detector module for a detector for the detection of ionizing radiation and detector

(76) Inventor: Peter Kaemmerer, Schnaittach (DE)

Correspondence Address: HARNESS, DICKEY & PIERCE, P.L.C., P.O.BOX 8910, RESTON, VA, 20195, US

(21) Appl. No.: 10/910,633

(22) Filed: Aug. 4, 2004

(30) Foreign Application Priority Data
Aug. 4, 2003 (DE) 10335662.2

(51) Int. Cl. G01T 1/24

(52) U.S. Cl. 250/370.01

(57) ABSTRACT

A detector module for a detector for the detection of ionizing radiation, in particular for use in a computer tomography machine, includes a printed circuit board and an array with a plurality of radiation-electrical transducer elements for the conversion of incident electromagnetic radiation into an electrical output signal. The printed circuit board includes a recess in which a plate, firmly connected to the printed circuit board is placed. The plate in turn—indirectly or directly—carries the array.

The present application hereby claims priority under 35 U.S.C. §119 on German patent application number DE 103 35 662.2 filed Aug. 4, 2003, the entire contents of which are hereby incorporated herein by reference.

### FIELD OF THE INVENTION

The invention generally relates to a detector module for a detector for the detection of ionizing radiation. In particular, it is directed to one for use in a computer tomography machine, with a printed circuit board and with an array. The array may be firmly connected to the printed circuit board and may have a plurality of radiation-electrical transducer elements for the conversion of incident electromagnetic radiation into an electrical output signal.

### BACKGROUND OF THE INVENTION

Detectors—constructed in a pixel layout—or detector modules are used in particular for imaging with ionizing radiation, in particular with X-radiation. A comparatively large array for each detector module then needs to be applied to a printed circuit board, which is used for delivering the electrical output signals obtained by the array from the array to an external evaluation instrument. The printed circuit board is also used for fastening the array.

Usually, the arrays are adhesively bonded to their associated printed circuit boards, in which case temperatures of between 80° C. and 150° C. may occur when curing. Undesirable bending or twisting of the printed circuit board may occur after curing, in particular if a standard printed circuit board is being used for this purpose, for example a printed circuit board of the FR-4 type.

One possible remedy might consist in applying a plate made of the same material as the array to the opposite side of the printed circuit board from the array. This would necessitate substantially simultaneous application of both the array and said additional plate, however, which is difficult in terms of production technology. The opposing plate can furthermore lead to undesirable extra costs.

Special thermally stable HTCC printed circuit boards are also known, but these are not viable for many applications owing to their high price.

### SUMMARY OF THE INVENTION

It is an object of an embodiment of the present invention to provide a detector module in which the array can be applied to the printed circuit board inexpensively but without significant risk of twisting or bending.

In relation to a detector, this object may be achieved according to an embodiment of the invention in that the printed circuit board has a recess in which a plate firmly connected to the printed circuit board is placed, with the plate—indirectly or directly—carrying the array.

In the detector module according to an embodiment of the invention, the plate can be made of a different advantageous material from the printed circuit board, and can thereby be matched to the specific properties of the array which is to be applied in a particular region of the printed circuit board. On the one hand, the opportunity is available to match the plate thermally to the array. On the other hand, by fitting the plate in the printed circuit board, it is possible to locally produce greater planarity, which is advantageous for the application of the array, than could be achieved with a low-cost printed circuit board without a recess.

Preferably, the array is—indirectly or directly—flatly connected, in particular via its entire side that faces away from the incident electromagnetic radiation, to the plate.

According to a particularly preferred configuration, the plate is thermally matched to the array so that the thermal coefficient of longitudinal expansion of the plate is greater or smaller than the corresponding value of the array by less than a factor of 3, preferably less than a factor of 2, in particular less than 50%. This applies in particular to the linear thermal coefficient of longitudinal expansion at room temperature. Bending can be reliably avoided with such a configuration when applying and curing the adhesive used for fastening the array, and increased thermal stability is likewise achieved during operation of the detector module.

The detector module may be used both in a scintillator-photodetector combination and in an array that converts ionizing radiation directly into electrical signals, in particular a semiconductor array. In the former case, the array is preferably a photodetector array, which detects the electromagnetic radiation as light quanta generated by the ionizing radiation in a scintillator layer. In the latter case, the ionizing radiation is identical to the electromagnetic radiation, which the array converts into the electrical output signal.

The array is preferably designed as a photodetector array based on silicon. Both photodiode arrays and CCD arrays may be employed.

The plate and the array are preferably adhesively bonded to each other.

According to a more particularly preferred configuration, the plate is made entirely or predominantly of ceramic, preferably of aluminum oxide, or entirely or predominantly of glass. The further potential advantages of the plate which is to be placed in the recess can be exploited in a particularly straightforward way with such a configuration. This is because plates made of ceramic or glass are particularly inexpensive and easy to produce with high planarity, which greatly facilitates the fastening or adhesive bonding of the array.

The recess is also preferably designed as a groove. As an alternative, it may also be designed as a through-opening in the printed circuit board.

It is particularly advantageous to place the plate in the recess so that it lies flush with the printed circuit board. Like a procedure in which the plate is placed on the printed circuit board without providing a recess and the array is applied on top, this configuration has the advantage that the array has its surface at only a small distance from the upper side of the printed circuit board, which significantly facilitates application of bonding wires.

### BRIEF DESCRIPTION OF THE DRAWINGS

An exemplary embodiment of a detector module and of a detector will be explained hereafter in more detail, referring to exemplary embodiments thereof with reference to FIGS. 1 and 2, in which:

FIG. 1 shows a detector module according to the invention in a longitudinal section, and

FIG. 2 shows a detector including a plurality of detector modules according to FIG. 1 in a plan view from the direction of the ionizing radiation.

### DETAILED DESCRIPTION OF THE PREFERRED EMBODIMENTS

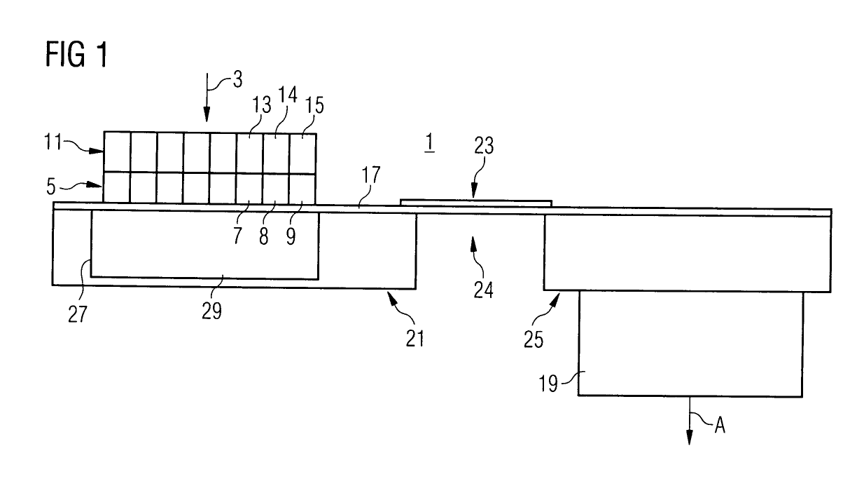

FIG. 1 shows a detector module, denoted overall by 1, for the detection of ionizing radiation 3, for example X-radiation. The detector module 1 has an array 5 with a plurality of radiation-electrical transducer elements 7, 8, 9, . . . designed as photodiodes.

As viewed from the direction of the ionizing radiation 3, a scintillator structure 11 which is structured in the same way as the array 5 is arranged in front of the array 5. Corresponding scintillator elements 13, 14, 15, . . . are arranged closely and flush over the corresponding transducer elements 7, 8, 9, . . . . In the scintillator layer 11 which consists of an ultrafast gadolinium-doped scintillator ceramic, for example, the incident ionizing radiation 3, in particular X-radiation, is converted into electromagnetic radiation or light which the array 5 in turn converts into a multiplicity of electrical output signals A. The electrical output signals A are sent via a ribbon-type conductor track bundle 17 (indicated only schematically) to a plug 19, from which they can be sent to the downstream signal processing.

The structure made up of the array 5 and the scintillator layer 11 is applied to an approximately 1.6 millimeter thick printed circuit board, which is designed as a standard FR-4 printed circuit board. The thickness of the array 5 is a few 100 μm.

For ease of installation in the detector support (not represented) of the associated computer tomography device, the rigid printed circuit board 21 is connected via a so-called flex strip 23 to another printed circuit board 25, which carries the plug 19. In this way, the entire detector module 1 can be bent in the region 24.

A groove or recess 27, in which a ceramic plate 29 made of aluminum oxide (Al₂O₃) is adhesively bonded, is machined into the printed circuit board 21 that carries the array 5. In the example of FIG. 1, the thickness of the plate 29 corresponds to the depth of the recess 27. The plate 29 preferably protrudes with less than 20% of its thickness out from the recess 27, or by less than 100 μm to 200 μm. It should protrude by less than 50% of the thickness of the array 5.

The printed circuit board 21 thereby provided with a ceramic inlay has the advantage that, by way of the plate 29, the mechanical and thermal properties that are advantageous for coupling the array 5 can be locally adjusted in a controlled way. By using aluminum oxide (alumina), for example, the linear thermal expansion coefficient of the assembly including the plate 29 and the printed circuit board 21 can be locally matched very well to the array 5. A high degree of planarity can furthermore be obtained by way of the plate 29, so that it is even possible to use (and not have to reject) printed circuit boards whose planarity lies outside the tolerance required for this.

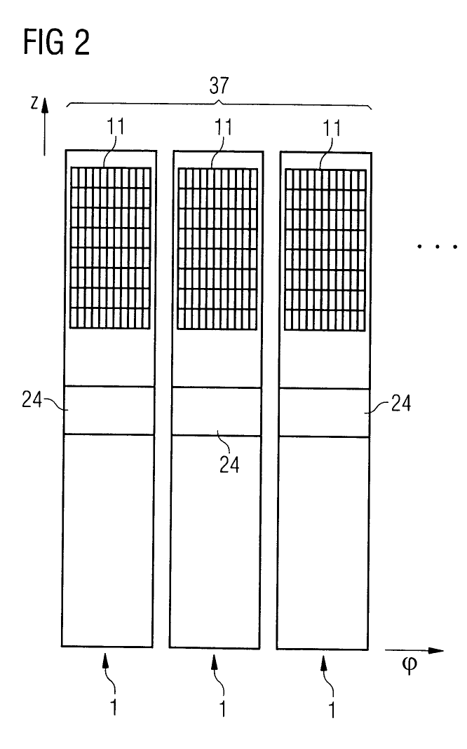

FIG. 2 shows a detector 37 according to an embodiment of the invention, which is composed of a plurality of identical detector modules 1 according to FIG. 1. The system axis Z of the relevant computer tomography machine and the rotation direction φ are indicated. The individual detector modules 1 are aligned on a curved support (not represented explicitly) in the rotation direction p. The detector 37 rotates about the rotation or symmetry axis Z during the data acquisition, in particular during the examination of a patient placed in the opening of a CT machine.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A detector module for a detector for the detection of ionizing radiation, comprising:
a printed circuit board; and
an array, firmly connected to the printed circuit board and including a plurality of radiation-electrical transducer elements for the conversion of incident electromagnetic radiation into an electrical output signal, wherein the printed circuit board includes a recess in which a plate, firmly connected to the printed circuit board, is placed, and wherein the plate carries the array.

2. The detector module as claimed in claim 1, wherein the array is at least one of indirectly and directly flatly connected to the plate.

3. The detector module as claimed in claim 1, wherein the thermal coefficient of longitudinal expansion of the plate is greater or smaller than the corresponding value of the array by less than a factor of 3.

4. The detector module as claimed in claim 1, wherein the array is a photodetector array which detects the electromagnetic radiation as light quanta generated by the ionizing radiation in a scintillator layer.

5. The detector module as claimed in claim 1, wherein the array is designed as a photodetector array based on silicon.

6. The detector module as claimed in claim 1, wherein the plate consists at least predominantly of ceramic, preferably of aluminum oxide, or entirely or predominantly of glass.

7. The detector module as claimed in claim 1, wherein the plate and the array are adhesively bonded to each other.

8. The detector module as claimed in claim 1, wherein the recess is designed as a groove.

9. The detector module as claimed in claim 1, wherein the plate is placed in the recess so that it lies flush with the printed circuit board.

10. A detector for the detection of ionizing radiation, comprising a plurality of detector modules as claimed in claim 1.

11. The detector module as claimed in claim 1, wherein the plate carries the array at least one of directly and indirectly.

12. The detector module as claimed in claim 1, wherein the detector module is for use in a computer tomography machine.

13. The detector module as claimed in claim 1, wherein the array is at least one of indirectly and directly flatly connected via its entire side that faces away from the incident electromagnetic radiation, to the plate.

14. The detector module as claimed in claim 1, wherein the thermal coefficient of longitudinal expansion of the plate is greater or smaller than the corresponding value of the array by less than a factor of 2.

15. The detector module as claimed in claim 1, wherein the thermal coefficient of longitudinal expansion of the plate is greater or smaller than the corresponding value of the array by less than 50%.

16. The detector module as claimed in claim 2, wherein the thermal coefficient of longitudinal expansion of the plate is greater or smaller than the corresponding value of the array by less than a factor of 3.

17. The detector module as claimed in claim 1, wherein the plate consists entirely of ceramic.

18. The detector module as claimed in claim 1, wherein the plate consists at least predominantly of aluminum oxide.

19. The detector module as claimed in claim 1, wherein the plate consists at least predominantly of glass.

20. The detector module as claimed in claim 1, wherein the plate consists entirely of glass.

21. The detector module as claimed in claim 8, wherein the plate is placed in the recess so that it lies flush with the printed circuit board.

22. A detector for the detection of ionizing radiation, comprising a plurality of detector modules, each detector module including, a printed circuit board, and an array, connected to the printed circuit board and including a plurality of radiation-electrical transducer elements for converting electromagnetic radiation into electrical signals, wherein the printed circuit board includes a recess in which a plate, connected to the printed circuit board, is placed, the plate being connected to the array.
